(19) United States
(12) Patent Application Publication
(10) Pub. No.: US 2009/0007522 A1
(43) Pub. Date: Jan. 8, 2009

(54) Method of Producing a Drink Contained in a Container

(75) Inventors: Shigeru Sakai, Kanagawa (JP); Katsumi Senbon, Kanagawa (JP); Takeshi Iwashita, Kanagawa (JP); Akira Abe, Tokyo (JP)

Correspondence Address: HEDMAN & COSTIGAN P.C., 1185 AVENUE OF THE AMERICAS, NEW YORK, NY, 10036, US

(73) Assignee: TOYO SEIKAN KAISHA, LTD, TOKYO (JP)

(21) Appl. No.: 12/223,578

(22) PCT Filed: Feb. 2, 2006
(86) PCT No.: PCT/JP2006/304220

§ 371 Date: Aug. 1, 2008

(51) Int. Cl. B65B 55/10; B67C 3/00; B67C 7/00; B65B 55/14

(52) U.S. Cl. 53/426; 53/440; 53/467

(57) ABSTRACT

A method of producing a drink contained in a container comprising steps of heating and thereby sterilizing a tea drink having pH of 4.6 or over and containing catechin in an amount of 30 mg % or over or an acidic drink having pH of less than 4.6 and thereafter maintaining the sterilized drink at a temperature within a range from 60° C. to 70° C. and, in the meanwhile, heating and thereby sterilizing and rinsing a container on at least its inner surface with heated water having a temperature within a range from 65° C. to 100° C., filling the drink in the sterilized container at a filling temperature within a range from 60° C. to 70° C. in an environment controlled space which is separated from an outside environment and in which filling and sealing apparatuses and an environment surrounding the filling and sealing apparatuses have been heated and thereby sterilized and rinsed with heated water having a temperature within a range from 65° C. to 100° C., and sealing the container filled with the drink and thereafter cooling the container to a normal temperature of 40° C. or below.

### TECHNICAL FIELD

This invention relates to a method of producing a drink contained in a container and, more particularly, to a method of producing a tea drink contained in a container and a method of producing an acidic drink contained in a container.

### BACKGROUND ART

Known in the art of method of producing drinks such as a tea drink and an acidic drink contained in a PET bottle is an aseptic filling method. According to this method, a drink which has been sterilized by heating at a high temperature for a short period of time by means of, e.g., a heat exchanger and then has been cooled promptly to a normal temperature is filled under a normal temperature in a container which has no heat resisting property and which has been sterilized with a sterilizer such as hydrogen peroxide or peraceptic acid and rinsed with sterilized water and then the container is sealed while an aseptic environment for filling and sealing is maintained.

This method requires a sterilizer processing apparatus and a sterilizer for sterilizing a container and also requires a rinsing apparatus and a large quantity of water for rinsing the container and, in addition, a cooling apparatus which promptly cools the drink to a normal temperature after sterilization by heating and, as a result, this method requires large scale apparatuses and a large scale control for these apparatuses.

There is also known a method called “hot pack” for producing such drink contained in a container. For example, Japanese Patent Application Laid-open Publication No. 2001-278225 and Hei 8-309841 disclose such method. According to this method, a drink which has been sterilized by heating is filled in a contained which has heat resisting property and which has been rinsed with water at a filling temperature of 85° C. in an environment which has been controlled to a scarcely contaminated environment in a clean room, the container filled with the drink is then sealed and is subjected to sterilization by rolling for about 30 seconds and sterilization by a pasteurizer by heating at 75° C. for 3 minutes and subsequently is cooled.

This method requires resistance (strength) of a container to deformation caused by reduction in pressure for preventing forming of a dent in a container due to reduction in pressure in a head space of the container caused by cooling of the drink after filling and sealing of the container. Moreover, the process of sterilization by heating by a pasteurizer after filling and sealing requires a large apparatus and this method requires a number of apparatuses under a high temperature which deteriorates a working environment.

As a kind of aseptic filling method, Japanese Patent No. 2844983 discloses a method of filling an acidic drink in a PET bottle. According to this method, heated water at a temperature within a range from 65° C. to 85° C. is intermittently injected from the mouth of a PET bottle held upside down to rinse at least an inner wall surface of the bottle, then an acidic drink which has been sterilized by heating is filled at a normal temperature in the bottle in a sterilized environment and then the bottle is sealed. This method is advantageous in that a process of sterilizing a container with a sterilizer and a process of rinsing of the container with a sterilized water can be substituted by a simpler sterilizing process by using heated water but the problem that this method requires an apparatus for promptly cooling the drink to a normal temperature after sterilization by heating and a control of this apparatus requires a large scale apparatus remains unsettled.

### DISCLOSURE OF THE INVENTION

This invention has been made to overcome the above described problems of the prior art method of producing a drink contained in a container. It is an object of the invention to provide a novel method of producing a drink contained in a container which, in contrast to the aseptic filling method, is capable of obviating use of a sterilizer and sterilized water and simplifying an apparatus and control for promptly cooling the drink to a normal temperature after sterilization by heating and, in contrast to the hot-pack method, is capable of mitigating conditions concerning resistance to deformation of a container caused by reduction in pressure and obviating the sterilizing process by heating after filling and sealing and thereby simplifying the equipment and improving the working environment.

Studies and experiments made by the inventors of the present invention for achieving the above described object of the invention have resulted in the finding, which has led to this invention, that by limiting the drink which is contents of the container to tea drinks such as a green tea drink and an oolong tea drink having pH of 4.6 or over and containing catechin in an amount of 30 mg % or over, and also an acidic drink having pH of less than 4.6, sterilization of the container by a sterilizer is not required, prompt cooling of the drink to a normal temperature after sterilization by heating is not required, and conditions concerning resistance to deformation of the container caused by reduction in pressure can be mitigated.

In the first aspect of the invention, there is provided a method of producing a drink contained in a container comprising steps of:
heating and thereby sterilizing a tea drink having pH of 4.6 or over and containing catechin in an amount of 30 mg % or over at a sterilization value which is equal to or over sterilization by heating at 135° C. for 7.58 seconds and thereafter maintaining the sterilized tea drink at a temperature within a range from 60° C. to 70° C.;
heating and thereby sterilizing and rinsing a container on at least its inner surface with heated water having a temperature within a range from 65° C. to 100° C.;
filling the tea drink in the sterilized container at a filling temperature within a range from 60° C. to 70° C. in an environment controlled space which is separated from an outside environment and in which filling and sealing apparatuses and an environment surrounding the filling and sealing apparatuses have been heated and thereby sterilized and rinsed with heated water having a temperature within a range from 65° C. to 100° C.; and
sealing the container filled with the tea drink and thereafter cooling the container to a normal temperature of 40° C. or below.

In the second aspect of the invention, there is provided a method of producing a drink contained in a container comprising steps of:

heating and thereby sterilizing an acidic drink having pH of less than 4.6 at a temperature within a range from 93° C. to 95° C. and thereafter maintaining the sterilized acidic drink at a temperature within a range from 60° C. to 70° C.;

heating and thereby sterilizing and rinsing a container on at least its inner surface with heated water having a temperature within a range from 65° C. to 100° C.;

filling the acidic drink in the sterilized container at a filling temperature within a range from 60° C. to 70° C. in an environment controlled space which is separated from an outside environment and in which filling and sealing apparatuses and an environment surrounding the filling and sealing apparatuses have been heated and thereby sterilized and rinsed with heated water having a temperature within a range from 65° C. to 100° C.; and

sealing the container filled with the acidic drink and thereafter cooling the container to a normal temperature of 40° C. or below.

In a preferred embodiment of the invention, the drink is maintained at a temperature within a range from 65° C. to 67° C. after heating for sterilization and before being filled in the container.

In another preferred embodiment of the invention, the environment controlled space is a space enclosed in a box.

According to the invention, by sterilizing a container by heating with heated water and then cooling and filling a drink at a filling temperature within a range from 60° C. to 70° C., preferably from 65° C. to 67° C., use of a sterilizer and sterilized water can be obviated and an apparatus and control for promptly cooling the drink to a normal temperature after sterilization by heating can be obviated and, therefore, the equipment can be significantly simplified in contrast to the aseptic filling method. In contrast to the hot-pack method, the drink can be filled at a filling temperature which is significantly lower than in the hot-pack method and conditions concerning resistance to deformation of a container caused by reduction in pressure can thereby be mitigated and thickness of the container can thereby be reduced and the cost of material can be saved. Further, since the sterilizing process by heating after filling and sealing can be obviated, the equipment can be simplified and the working environment can be improved as compared with the hot-pack method.

### BRIEF DESCRIPTION OF THE DRAWINGS

FIG. 1 is a flow chart showing an embodiment of the method of the present invention.

FIG. 2 is an explanatory view showing an example of a method for sterilizing a bottle by heated water.

FIG. 3 is a view schematically showing an example of a sterilizing apparatus provided in an environment controlled space.

### DESCRIPTION OF PREFERRED EMBODIMENTS

An embodiment of the invention will now be described with reference to the accompanying drawings.

Drinks to which the present invention is applied are tea drinks including a green tea drink and an oolong tea drink having a pH of 4.6 or over and containing catechin in an amount of 30 mg %, and acidic drinks having pH of less than 4.6. The acidic drinks include natural fruit juices, fruit juice drinks, juices with fruit flesh, soft drinks containing fruit juices, fruit juices with pulp, lemon tea and sports drinks.

Containers used for the method of the present invention comprise plastic containers including polyester containers such as polyester bottles, e.g., PET bottles, and polyester cups and trays, glass bottles, metal bottles and food cans. The invention is particularly suitable for producing the above described drinks contained in PET bottles, for the conditions concerning resistance to deformation of the container caused by reduction in pressure can be mitigated and thickness of the bottles can thereby be reduced.

In the method of the present invention, after heating and thereby sterilizing a drink which is contents of a container, the sterilized drink is maintained at a temperature within a range from 60° C. to 70° C., preferably from 65° C. to 67° C. and, in the meanwhile, a container is heated and thereby sterilized and rinsed on at least its inner surface with heated water having a temperature within a range from 65° C. to 100° C. The drink is filled in the sterilized container at a filling temperature within a range from 60° C. to 70° C., preferably from 65° C. to 67° C. in an environment controlled space which is separated from an outside environment and in which filling and sealing apparatuses and an environment surrounding the filling and sealing apparatuses have been heated and thereby sterilized and rinsed with heated water having a temperature within a range from 65° C. to less than 100° C., and the container filled with the drink is sealed and thereafter is cooled to a normal temperature of 40° C. or below.

In a case where the contents of the container are a tea drink, the tea drink is sterilized by heating by a known high temperature short time sterilizing method (HTST sterilization) using a heat exchanger or other method at a sterilization value which is equal to or over sterilization by heating at 135° C. for 7.58 seconds and then is maintained at a temperature within a range from 60° C. to 70° C., preferably from 65° C. to 67° C. in a head tank unit. In a case where the contents of the container are an acidic drink, the acidic drink is sterilized by heating at a temperature within a range from 93° C. to 95° C. by a high temperature short time sterilizing method or other method and then is maintained at a temperature within a range from 60° C. to 70° C., preferably from 65° C. to 67° C. in a head tank unit.

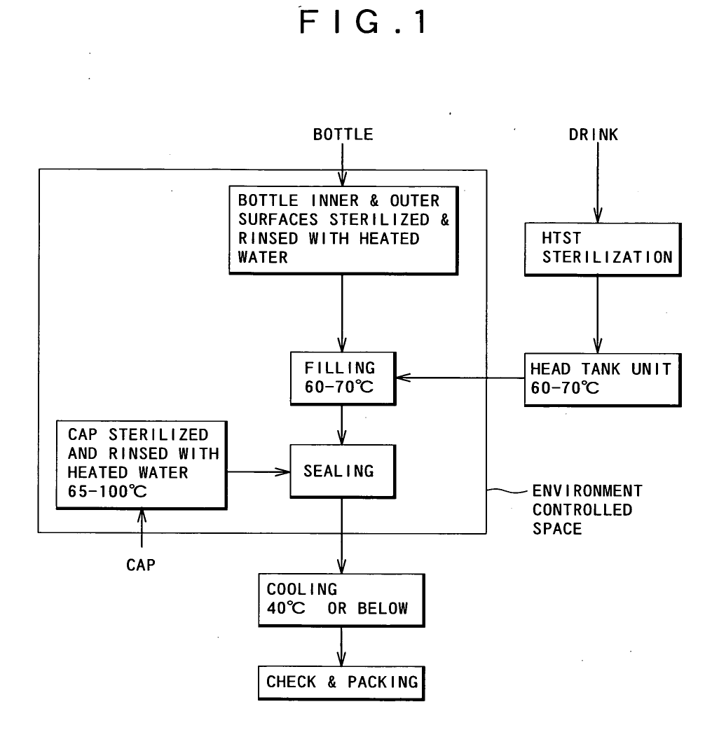

As a typical example, a case where such a drink is filled in a PET bottle will be described with reference to a chart of FIG. 1. In the present specification, the term “environment controlled space” means a space which is separated from outside environment and in which filling and sealing apparatuses and an environment surrounding the filling and sealing apparatuses have been heated and thereby sterilized and rinsed with heated water having a temperature within a range from 65° C. to 100° C.

In this embodiment, a bottle which is shifted from a bottle supply apparatus provided in a space outside of the environment controlled space to a bottle sterilizing and rinsing apparatus provided in the environment controlled space is sterilized on at least an inner surface, preferably in inner and outer surfaces, of the bottle by heating with heated water at a temperature within a range from 65° C. to 100° C. Sterilization time is 3 to 10 seconds. According to this method, sterilization of the bottle and rinsing of the bottle are simultaneously performed so that a separate process of rinsing the bottle after sterilization is unnecessary.

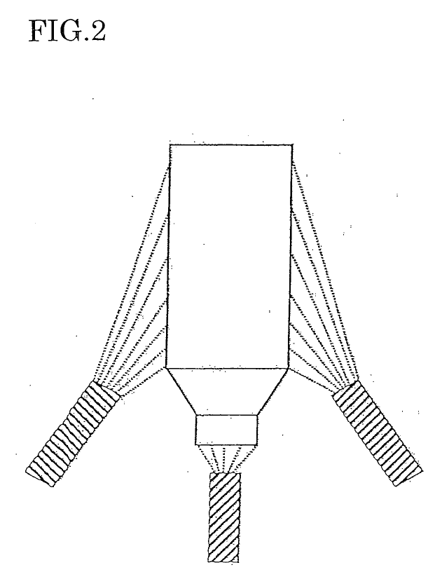

Sterilization of the inner and outer surfaces of the bottle can be made by, for example, disposing the bottle upside down and injecting heated water from a heated water spray nozzle as shown in FIG. 2.

After sterilization of the inner and outer surfaces of the bottle, the bottle is shifted to a filler provided in the environment controlled space and a drink held in a head tank unit is filled in the bottle. In the head tank unit, the drink is held at a temperature within a range from 60° C. to 70° C., preferably from 65° C. to 67° C. and, therefore, the drink is filled in the bottle at a temperature selected within this temperature range. A filling temperature exceeding 70° C. is unnecessary for the selected type of drinks according to the present invention and such temperature is disadvantageous because it will be waste of energy and, moreover, it will make severer the conditions concerning resistance of the bottle to deformation caused by reduction in pressure. If the filling temperature is less than 60° C., it will be difficult to attain sufficient sterilization.

The bottle filled with the drink is shifted from the filler to a capper which is provided in the environment controlled space and is completely sealed with a cap which has been supplied from a cap supply apparatus provided in a space outside of the environment controlled space to a cap sterilizing and rinsing apparatus provided in the environment controlled space where the cap has been sterilized and rinsed under the same condition as the condition under which the bottle is sterilized and rinsed. Then, the bottle thus sealed is cooled to a normal temperature of 40° C. or below by a simple type cooling apparatus such as a cooling shower provided in a space outside of the environment controlled space, and is shipped as a drink product through checking and packing processes.

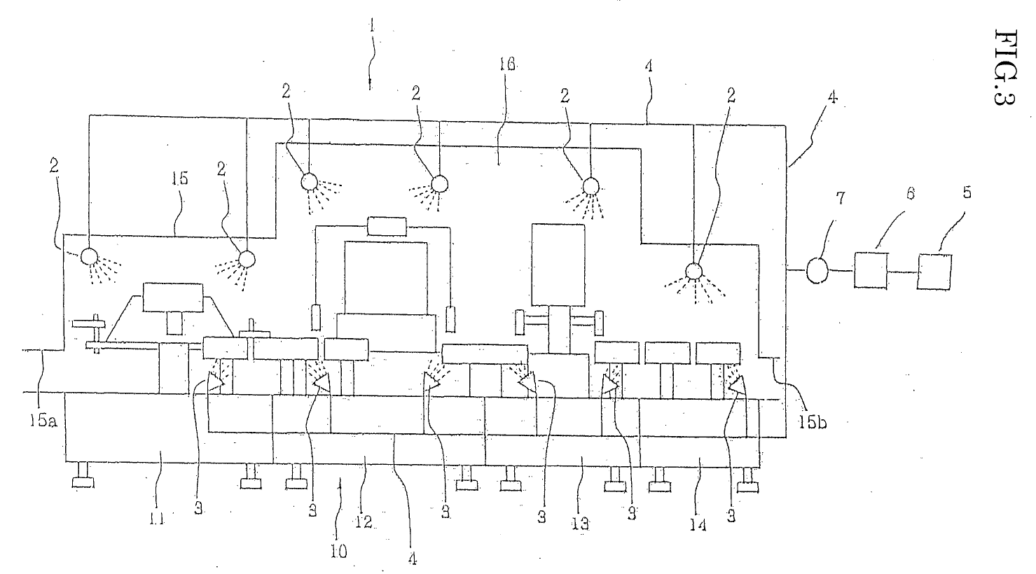

A specific example of apparatuses which carry out processes of sterilization of inner and outer surfaces of a bottle, filling of a drink, and capping (sealing) is shown schematically in FIG. 3.

In FIG. 3, a drink filling apparatus 10 is a filling apparatus which fills a drink in a PET bottle which comprises, in the direction of conveying a PET bottle, a bottle rinser 11 which sterilizes inner and outer surfaces of the bottle, a filler 12, a capper 13, and a sorter 14 which sorts out bottles in two lines. The drink filling apparatus 10 is covered with a cover 15 made of a steel plate. A box 16 constituting the environment controlled space is formed by this cover 15.

The cover 15 is formed with a bottle inlet 15a and a bottle outlet 15b but the box 16 is substantially closed.

An environment controlled space sterilizing apparatus 1 comprises a plurality of rotary nozzles 2 and a plurality of stationary nozzles 3 which constitute means for spraying heated water in the box 16. The rotary nozzles 2 are made of spray balls which are disposed in the upper portion of the box 16 with their injection openings directed downwardly. The stationary nozzles 3 are made of full corn nozzles which are disposed in the vicinity of the floor in the lower portion of the box 16 with their injection openings directed obliquely upwardly. The rotary nozzles 2 and the stationary nozzles 3 are respectively connected to a heated water supply source 5 with a pipe lining 4 via a valve 7 and a heater 6 and can receive heated water supplied from the supply source 5.

In a case where sterilization is made by using these apparatuses, the valve 7 is operated to connect the pipe lining 4 to the heated water supply source 5. Water from the heated water supply source 5 is heated by the heater 6 and supplied to the rotary nozzles 2 and the stationary nozzles 3 in the box 16 via the pipe lining 4 and the heated water is sprayed from these nozzles into the box 16. The sprayed heated water falls onto a major portion of surfaces of objects to be sterilized including the outer surfaces of the apparatuses including the bottle rinser 11, filler 12, capper 13 and sorter 14, the inner surface of the box 16 and a pipe lining (not shown) for supplying heated water to the bottle rinser etc. and wets these portions. The sprayed heated water sterilizes the major portion of the surfaces of the objects to be sterilized by wetting them and steam which has evaporated fills the inside space of the box 16 and contacts all surfaces of the objects to be sterilized including portions which have not been wetted by the heated water whereby further sterilization is performed. By continuing spraying of the heated water for a predetermined period of time, complete sterilization of the entire surfaces of the objects to be sterilized can be achieved. In this case, the inner wall surface of the box 16 which is the inner wall surface of the environment controlled space can also be sufficiently sterilized in its entirety in the same manner as the surfaces of the apparatuses.

Heating of the heated water is adjusted so that the sterilizing temperature will become 65° C. or over on the surface of the object to be sterilized and 100° C. or below, preferably less than 96° C. because sterilization is made under atmospheric pressure.

### EXAMPLE

An example of the present invention will now be described.

### Example 1

A green tea drink (pH 5.9, amount of catechin 52 mg %) was produced by using a 500 ml PET bottle and by the above described method and apparatuses. More specifically, a green tea drink which was sterilized by HTST sterilization at 135° C. for 30 seconds and then cooled to 65° C. was filled in the bottle which was sterilized and rinsed with heated water at 90° C. for 3 seconds by a filler and the bottle was sealed by a capper which were provided in an environment controlled space separated from outside space by a box and were sterilized and rinsed under the same conditions as the bottle. Then, the bottled green tea drink was cooled to a normal temperature with a simple cooling shower. The drink was kept at a temperature of 30° C. for two weeks and then how the contents were affected by microorganisms was visually examined. As a result, the state of the green tea drink was good and no turbidity due to change of quality by microorganisms was observed at all.

### Comparative Example 1

A drink bottled in a PET bottle was produced under the same conditions as in Example 1 except that a mixed tea having catechin in an amount of 12 mg % was used. The drink after being kept for two weeks at 30° C. exhibited turbidity, showing that change of quality due to microorganisms occurred.

### Comparative Example 2

A drink bottled in a PET bottle was produced under the same conditions as in Example 1 except that a barley water (an amount of catechin could not be detected) was used. The drink after being kept for two weeks at 30° C. exhibited turbidity, showing that change of quality due to microorganisms occurred.

### Comparative Example 3

A drink was produced under the same conditions as in Example 1 except that the bottle was not sterilized with heated water but was only rinsed with water, the filling apparatus etc. were not shielded by a box and were not sterilized with heated water but were only rinsed with water. The drink after being kept for two weeks at 30° C. exhibited turbidity, showing that change of quality due to microorganisms occurred.

As a result of these experiments, the drinks of the comparative examples all exhibited change of quality due to microorganisms, showing that the production method according to the present invention was superior to the methods of the comparative examples.

### INDUSTRIAL UTILITY

The present invention can be applied to production of drinks contained in containers, and is particularly useful for production of a tea drink having pH of 4.6 or over and having catechin in an amount of 30 mg % or over and production of an acidic drink having pH of less than 4.6. The acidic drinks include natural fruit juices, fruit juice drinks, juices with fruit flesh, soft drinks containing fruit juices, fruit juices with pulp, lemon tea and sports drinks.

1-4. (canceled)

5. A method of producing a drink contained in a container comprising steps of:
heating and thereby sterilizing a tea drink having pH of 4.6 or over and containing catechin in an amount of 30 mg % or over at a sterilization value which is equal to or over sterilization by heating at 135° C. for 7.58 seconds and thereafter maintaining the sterilized tea drink at a temperature within a range from 60° C. to 70° C.;
heating and thereby sterilizing and rinsing a container on at least its inner surface with heated water having a temperature within a range from 65° C. to 100° C.;
filling the tea drink in the sterilized container at a filling temperature within a range from 60° C. to 70° C. in an environment controlled space which is separated from an outside environment and in which filling and sealing apparatuses and an environment surrounding the filling and sealing apparatuses have been heated and thereby sterilized and rinsed with heated water having a temperature within a range from 65° C. to 100° C.; and
sealing the container filled with the tea drink and thereafter cooling the container to a normal temperature of 40° C. or below.

6. A method of producing a drink contained in a container comprising steps of:
heating and thereby sterilizing an acidic drink having pH of less than 4.6 at a temperature within a range from 93° C. to 95° C. and thereafter maintaining the sterilized acidic drink at a temperature within a range from 60° C. to 70° C.;
heating and thereby sterilizing and rinsing a container on at least its inner surface with heated water having a temperature within a range from 65° C. to 100° C.;
filling the acidic drink in the sterilized container at a filling temperature within a range from 60° C. to 70° C. in an environment controlled space which is separated from an outside environment and in which filling and sealing apparatuses and an environment surrounding the filling and sealing apparatuses have been heated and thereby sterilized and rinsed with heated water having a temperature within a range from 65° C. to 100° C.; and
sealing the container filled with the acidic drink and thereafter cooling the container to a normal temperature of 40° C. or below.

7. A method of producing a drink contained in a container as defined in claim 5 wherein the drink is maintained at a temperature within a range from 65° C. to 67° C. after heating for sterilization and before being filled in the container.

8. A method of producing a drink contained in a container as defined in claim 6 wherein the drink is maintained at a temperature within a range from 65° C. to 67° C. after heating for sterilization and before being filled in the container.

9. A method of producing a drink contained in a container as defined in claim 5 wherein the environment controlled space is a space enclosed in a box.

10. A method of producing a drink contained in a container as defined in claim 6 wherein the environment controlled space is a space enclosed in a box.
